(19) United States
(12) Patent Application Publication
(10) Pub. No.: US 2025/0105303 A1
(43) Pub. Date: Mar. 27, 2025

(54) METHOD AND SYSTEM FOR CARBON COMPOSITIONS AS CONDUCTIVE ADDITIVES FOR DENSE AND CONDUCTIVE CATHODES

(71) Applicant: Enevate Corporation, Irvine, CA (US)

(72) Inventors: Younes Ansari, Irvine, CA (US); Jeremy Chang, Irvine, CA (US); Benjamin Park, Mission Viejo, CA (US)

(21) Appl. No.: 18/906,320

(22) Filed: Oct. 4, 2024

Related U.S. Application Data
(63) Continuation of application No. 16/722,442, filed on Dec. 20, 2019, now abandoned.

(51) Int. Cl. H01M 4/66; H01M 4/134; H01M 4/505; H01M 4/525; H01M 10/0525; H01M 10/0562; H01M 10/0566

(52) U.S. Cl. CPC H01M 4/663; H01M 4/134; H01M 4/505; H01M 4/525; H01M 10/0525; H01M 10/0562; H01M 10/0566

(57) ABSTRACT

Systems and methods are provided for forming of batteries using carbon compositions as conductive additives for dense and conductive cathodes. An example battery may include an anode, an electrolyte, and a cathode including an active material, with the active material including 0D conductive carbon particles with nanoscale structure in three dimensions, and 1D conductive carbon particles with nanoscale structure in two dimensions. A ratio of the 1D conductive carbon particles to the 0D conductive carbon particles in the active material may be between 0.5 and 2. For example, the ratio of the 1D conductive carbon particles to the 0D conductive carbon particles may be approximately 1. The 1D carbon particles have a diameter of less than 120 nm, a surface area of 30 m²/g, and/or a dispersive surface energy of more than 180 mJ/m². The 0D and 1D particles may comprise between 1% and 10% of the active material.

### CLAIM OF PRIORITY AND CROSS-REFERENCE TO RELATED APPLICATIONS/INCORPORATION BY REFERENCE

This patent application is a continuation of U.S. patent application Ser. No. 16/722,442, filed on Dec. 20, 2019. The above identified application is hereby incorporated herein by reference in its entirety.

### FIELD

Aspects of the present disclosure relate to energy generation and storage. More specifically, certain embodiments of the disclosure relate to a method and system for carbon compositions as conductive additives for dense and conductive cathodes.

### BACKGROUND

Conventional approaches for battery cathodes may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method for carbon compositions as conductive additives for dense and conductive cathodes, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram of a battery, in accordance with an example embodiment of the disclosure.

FIG. 2 illustrates a graphic representation of binary and ternary carbon composites, in accordance with an example embodiment of the disclosure.

FIG. 3 is a flow diagram of a direct coating process for forming a cell with carbon composite cathode, in accordance with an example embodiment of the disclosure.

FIG. 4 is a flow diagram of an alternative process for lamination of electrodes, in accordance with an example embodiment of the disclosure.

FIG. 5 illustrates cathode resistances with various carbon additives, in accordance with an example embodiment of the disclosure.

FIG. 6 density of cathodes with various carbon additives, in accordance with an example embodiment of the disclosure.

FIG. 7 illustrates through-resistances of cathodes with varying carbon additive composition, in accordance with an example embodiment of the disclosure.

FIG. 8 illustrates Galvanostatic cycling performance of cells with a control cathode versus non-standard cathodes having a mixture of 0D and 1D conductive carbon as additive, in accordance with an example embodiment of the disclosure.

### DETAILED DESCRIPTION OF THE INVENTION

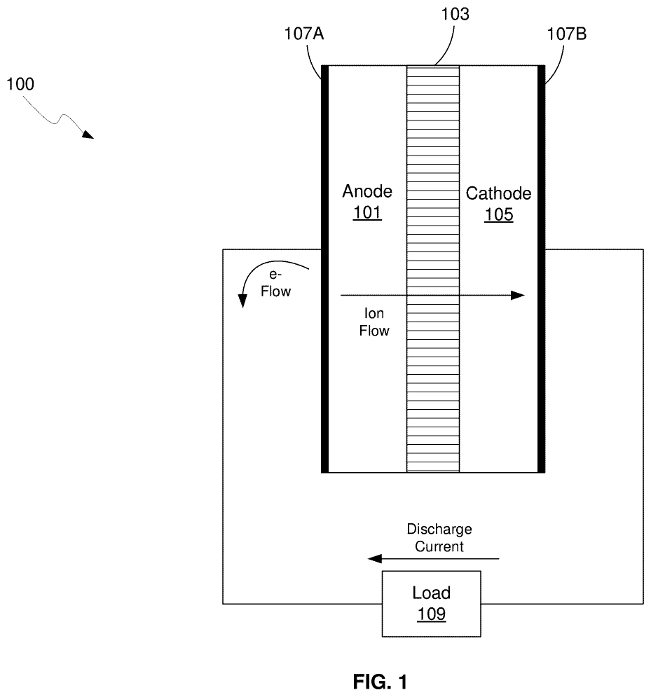

FIG. 1 is a diagram of a battery, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 107B, which comprise metal or other conductive material for providing electrical contact to the electrodes as well as physical support for the active material in forming electrodes.

The configuration shown in FIG. 1 illustrates the battery 100 in discharge mode, whereas in a charging configuration, the load 107 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte and may comprise a solid lithium ion conductor, or semi-solid lithium ion conductor. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc, a solid lithium ion conductor, or semi-solid lithium ion conductor. The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 107B. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (SuperP), vapor grown carbon fibers (VGCF), and a mixture of the two have previously been incorporated separately into the anode electrode resulting in improved performance of the anode. The synergistic interactions between the two carbon materials may facilitate electrical contact throughout the large volume changes of the silicon anode during charge and discharge.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (3579 mAh/g vs. 372 mAh/g for graphite) and volumetric capacities (2194 mAh/L vs. 890 mAh/L for graphite). In addition, silicon-based anodes have a lithiation/delithiation voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

A solution to enhance the electrical conductivity of Li-ion battery anodes and cathodes is to add conductive carbon additives. Two primary benefits of adding conductive additives to anodes and cathodes are improved particle-to-particle conductivity and improved particle-to-current-collector conductivity. These additives maintain conductive pathways for electrons, minimizing capacity loss in electrode active materials and, thus, enhancing the overall performance of Li-ion batteries. Because of the large volume changes of silicon-dominant anodes, maintaining conductive pathways throughout volume changes remains challenging. Typically, Li-ion batteries employ carbon additives with rigid structures, which do not flex, to accommodate the volume changes. In an example embodiment of this disclosure, high-performance anode materials are prepared by adding a blend of conducting additives with different morphologies to the anode, which accommodate the volume changes of electrodes during cycling by utilizing a “cushion effect”.

Among all the potential cathode active materials, NCA (Nickel cobalt aluminum oxide) and NCM (Nickel Cobalt Manganese Oxide) are considered one of the most promising. NCA shows excellent thermodynamic stability and specific capacity as high as 200 mAh/g. Although NCA is best known for its long-term stability and high energy density, it has also been shown to be problematic due to its poor cycle stability and low electronic conductivity. Poor electronic conductivity of the materials consequently impairs its electrochemical performance. Although NCA and NCM conductivities are higher than olivine cathodes, carbon is still needed as an additive to the cathode in order to improve its conductivity. To improve conductivity in the cathode, carbon compositions comprising of at least, 0D conductive carbons (a porous and high surface area carbon materials such as SuperP, Ketjen Black, etc.); and 1D conductive carbons (a tubular carbon source with nanoscale structures in two dimensions such as carbon nanotubes, carbon nanofibers (CNF), and vapor grown carbon fibers (VGCF), etc.) may be added to the composition. These carbon additives may provide benefits over conventional carbons such they can be easier to disperse and process, in addition to providing better mechanical and electrical properties. The performance of electrochemical electrodes, while dependent on many factors, is largely dependent on the robustness of electrical contact between electrode particles, as well as between the current collector and the electrode particles. In this disclosure, dense and high-performance cathode materials are prepared by adding a blend of conducting additives with different morphologies to the cathode.

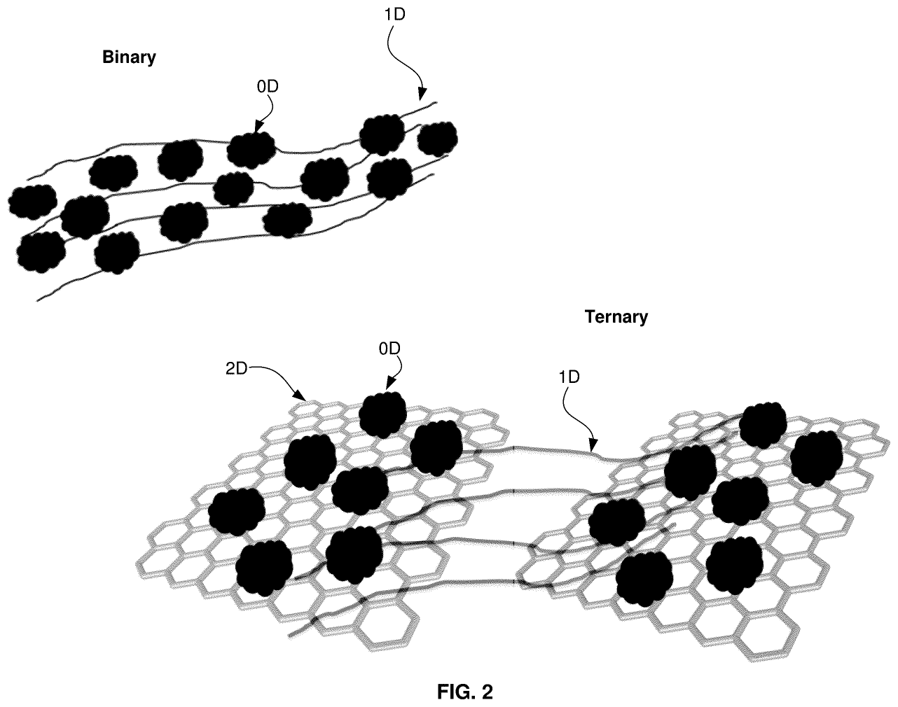

FIG. 2 illustrates a graphic representation of binary and ternary carbon composites, in accordance with an example embodiment of the disclosure. The various material types are labeled 0D, 1D, and 2D to indicate the number of dimensions in which the structures are not confined to nanoscale dimensions, i.e., the number of dimensions in which the structure extends beyond nanoscale distances. For example, a planar structure, such as graphene is confined in one dimension, e.g., one atomic layer, but extends larger distances in two dimensions, while a carbon nanotube is essentially linear, being confined in two dimensions but extends in one dimension well beyond the dimension of the structure on the two nanoscale dimensions, with an aspect ratio of 20 or greater, for example. A 0D structure is confined to small size in all three dimensions, i.e., very small particles such as carbon black, akin to quantum dots in quantum structures, and may comprise substantially spherical shapes.

The fibrous VGCF (1D) in conjunction with Super P (0D) and graphene platelets (2D) form electrical pathways that can stretch, offering continuous electrical contact with silicon and/or carbon particles during volume changes in the electrode. The specific mix of carbons allows for the carbons to interact with each other and maintain the conductive network easier. For example, one explanation may be that the 0D materials provide many moving connection points between the 1D and 2D materials. The 2D structures can slide against other 2D structures and the 1D materials can provide “bridges” between different conductive zones.

The conjugated carbon matrix described in this disclosure easily disperses in the cathode slurry, enabling denser electrodes, and shows improvement in the electrical conductivity of the cathode. In one example, VGCF with certain characteristics, hereinafter referred to as HP_VGCF, has (a) fiber diameter <120 nm, (b) surface area >30 m²/g, and dispersive surface energy of <180 mJ/m², results in improved cathode performance. VGCF with larger fiber diameter and lower surface area is hereinafter referred to as LP_VGCF.

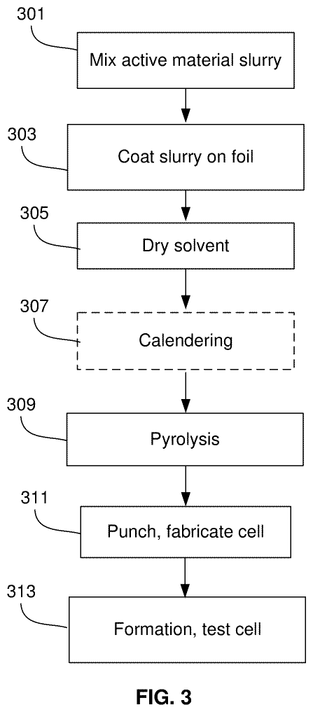

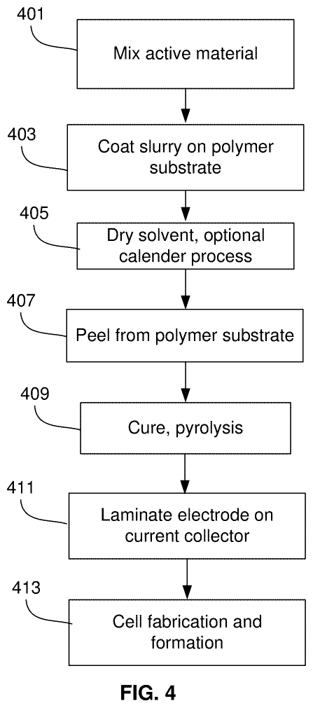

FIG. 3 is a flow diagram of a direct coating process for forming a cell with carbon composite cathode, in accordance with an example embodiment of the disclosure. This process comprises physically mixing the active material, conductive additive, and binder together, and coating it directly on a current collector. This example process comprises a direct coating process in which an anode slurry is directly coated on a copper foil using a binder such as CMC, SBR, Sodium Alginate, PAI, PAA, PI and mixtures and combinations thereof. Another example process comprising forming the active material on a substrate and then transferring to the current collector is described with respect to FIG. 4.

In step 301, the raw electrode active material may be mixed using a binder/resin (such as PI, PAI), solvent, and conductive carbon. For example, for the cathode, Super P/VGCF (1:1 by weight) may be dispersed in binder solution (mixture of NMP and PVDF) for 0.5 to 2 minutes at 1500-2500 rpm. NCA cathode material powder may be added to the mixture along with NMP solvent, then dispersed for another 1-3 minutes at 1500-2500 rpm to achieve a slurry viscosity within 2000-4000 cP (total solid content of about 48%). Another example composite material comprises a blend of Ketjen Black ECP/HP_VGCF (1:1 by weight). A similar process may be utilized to mix the active material slurry for the anode.

In step 303, the cathode slurry may be coated on an aluminum foil at a loading of, e.g., 15-25 mg/cm². Similarly, the anode slurry may be coated on a copper foil at a loading of 3-4 mg/cm², which may undergo drying in step 305 resulting in less than 13-20% residual solvent content.

In step 307, an optional calendering process may be utilized where a series of hard pressure rollers may be used to finish the film/substrate into a smoother and denser sheet of material.

In step 309, the active material may be pyrolyzed by heating to 500-800 C such that carbon precursors are partially or completely converted into glassy carbon. Pyrolysis can be done either in roll form or after punching in step 311. If done in roll form, the punching is done after the pyrolysis process. The punched electrode may then be sandwiched with a separator and cathode with electrolyte to form a cell. In step 313, the cell may be subjected to a formation process, comprising initial charge and discharge steps to lithiate the anode, with some residual lithium remaining and cell testing to determine performance.

FIG. 4 is a flow diagram of an alternative process for lamination of electrodes, in accordance with an example embodiment of the disclosure. While the previous process to fabricate composite anodes employs a direct coating process, this process physically mixes the active material, conductive additive, and binder together coupled with peeling and lamination processes.

This process is shown in the flow diagram of FIG. 4, starting with step 401 where the raw electrode active material may be mixed using a binder/resin (such as PI, PAI), solvent, and conductive carbon. For example, for the cathode, Super P/VGCF (1:1 by weight) may be dispersed in binder solution (mixture of NMP and PVDF) for 0.5 to 2 minutes at 1500-2500 rpm. NCA cathode material powder may be added to the mixture along with NMP solvent, then dispersed for another 1-3 minutes at 1500-2500 rpm to achieve a slurry viscosity within 2000-4000 cP (total solid content of about 48%). A similar process may be utilized to mix the active material slurry for the anode.

In step 403, the slurry may be coated on a polymer substrate, such as polyethylene terephthalate (PET), polypropylene (PP), or Mylar. The slurry may be coated on the PET/PP/Mylar film at a loading of 3-4 mg/cm² (with 13-20% solvent content) for the anode and 15-25 mg/cm² for the cathode, and then dried to remove a portion of the solvent in step 405. An optional calendering process may be utilized where a series of hard pressure rollers may be used to finish the film/substrate into a smoothed and denser sheet of material.

In step 407, the green film may then be removed from the PET, where the active material may be peeled off the polymer substrate, the peeling process being optional for a polypropylene (PP) substrate, since PP can leave ˜2% char residue upon pyrolysis. The peeling may be followed by a cure and pyrolysis step 409 where the film may be cut into sheets, and vacuum dried using a two-stage process (100-140° C. for 15 h, 200-240° C. for 5 h). The dry film may be thermally treated at 1000-1300° C. to convert the polymer matrix into carbon.

In step 411, the pyrolyzed material may be flat press or roll press laminated on the current collector, where for aluminum foil for the cathode and copper foil for the anode may be coated with polyamide-imide with a nominal loading of 0.35-0.75 mg/cm² (applied as a 5-7 wt % varnish in NMP, dried 10-20 hour at 100-140° C. under vacuum). In flat press lamination, the active material composite film may be laminated to the coated aluminum or copper using a heated hydraulic press (30-70 seconds, 250-350° C., and 3000-5000 psi), thereby forming the finished composite electrode. In another embodiment, the pyrolyzed material may be roll-press laminated to the current collector.

In step 413, the electrodes may then be sandwiched with a separator and electrolyte to form a cell. The cell may be subjected to a formation process, comprising initial charge and discharge steps to lithiate the anode, with some residual lithium remaining, and testing to assess cell performance.

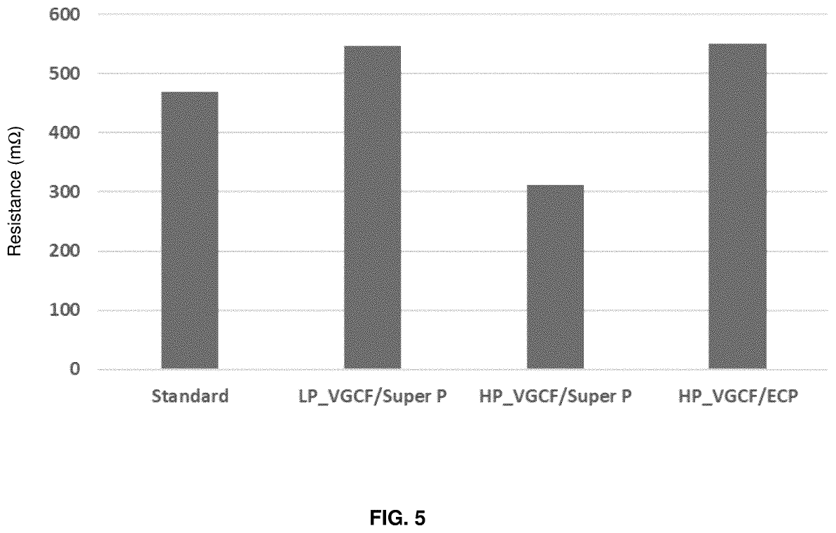

FIG. 5 illustrates cathode resistances with various carbon additives, in accordance with an example embodiment of the disclosure. Referring to FIG. 5, there is shown resistance measurements in mΩ across a standard cathode without carbon additives, a cathode with LP_VGCF and Super P, a cathode with HP_VGCF and Super P, and a cathode with HP_VGCF and carbon black ECP. As seen in FIG. 5, the HP_VGCF and Super P cathode had the lowest resistance.

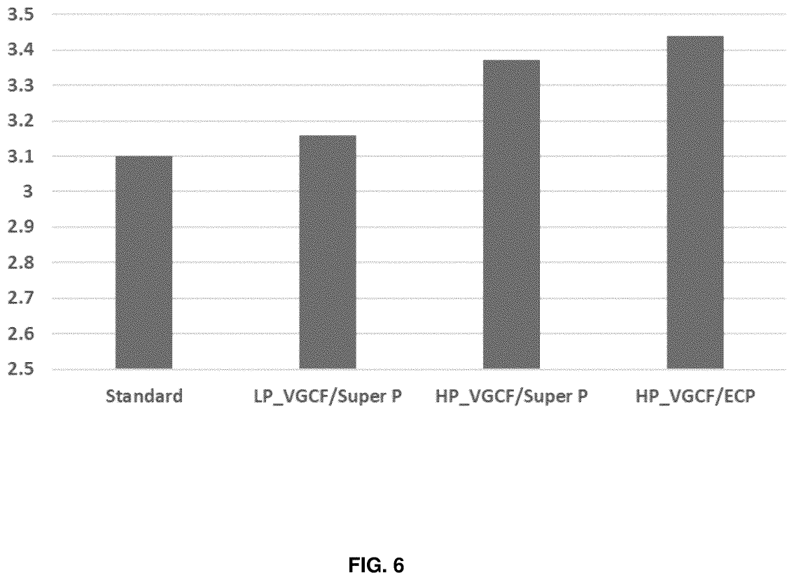

FIG. 6 density of cathodes with various carbon additives, in accordance with an example embodiment of the disclosure. Referring to FIG. 6, there are shown density of a standard cathode without carbon additives, a cathode with LP_VGCF and Super P, a cathode with HP_VGCF and Super P, and a cathode with HP_VGCF and carbon black ECP. The density measurements represent the cathode after calendering. As seen in FIG. 6, the HP_VGCF/Super P and HP_VGCF/ECP had the highest achievable density at about 3.4 g/cc.

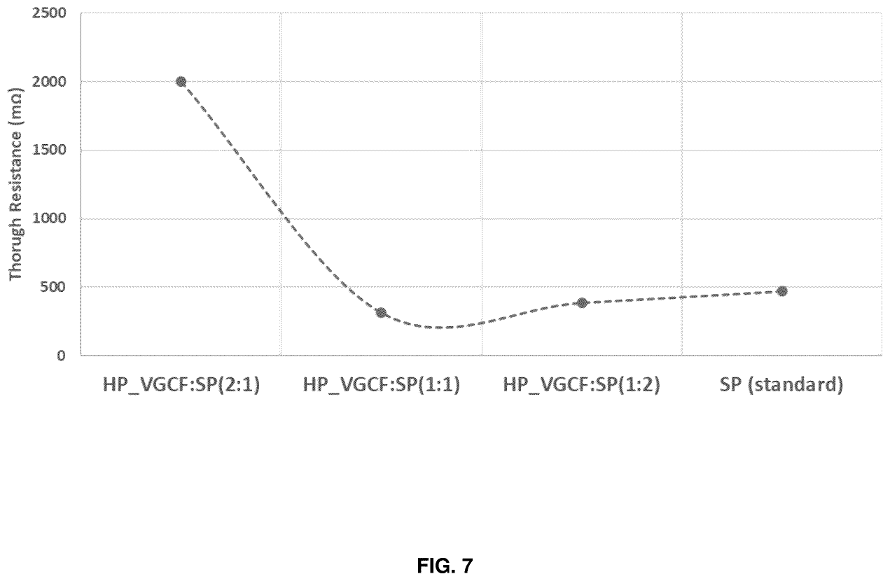

FIG. 7 illustrates through-resistance of cathodes with varying carbon additive composition, in accordance with an example embodiment of the disclosure. Referring to FIG. 7, there are shown through-resistances in mΩ for cathodes with various carbon additive composition with HP_VGCF to Super ratios of 2:1, 1:1, and 1:2, as well as a standard cathode without added VGCF/Super P. The plot illustrates that when the ratio of the HP_VGCF:SP reaches close to 1:1, the electrode shows the lowest resistance.

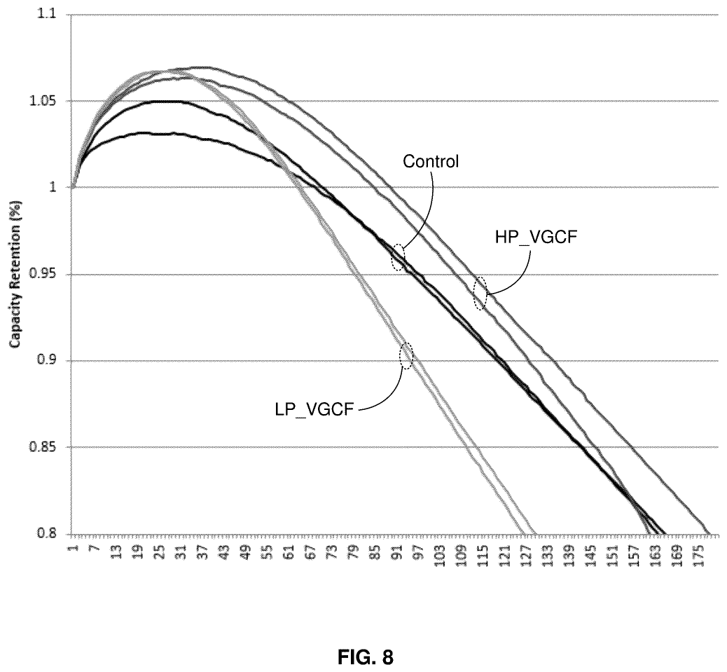

FIG. 8 illustrates Galvanostatic cycling performance of cells with a control cathode versus non-standard cathodes having a mixture of 0D and 1D conductive carbon as additive, in accordance with an example embodiment of the disclosure. Referring to FIG. 8, the capacity retention percentage is shown for each of the cathode types. In this example, the HP_VGCF and LP_VGCF cathodes comprise active material with 4% of the control cathode replaced with a mixture of a 0D carbon (SP) and 1D carbon (carbon fiber) with a ratio of 1:1. The plot shows that the addition of the binary carbon mixture utilizing HP_VGCF improves performance versus the control cathode, while the same amount with LP_VGCF reduces performance compared to the control and HP_VGCF.

The data disclosed above illustrate that the carbon additives may result in reduced cell resistance, improved density, improved cyclability, and improved rate capability. The cathode active material may comprise 0D conductive carbon comprising materials such as Super P, Ketjen Black, for example, and 1D conductive carbon comprising materials such as carbon nanotubes, carbon nanofibers, and vapor grown carbon fibers (VGCF). The carbon additive may comprise between 1 and 10% of the total cathode active material composition. The 1D conductive carbon tubes may have a diameter of 120 nm or less and a surface area if greater than 30 m²/g. The carbon mixture may comprise VGCF and at least one of the following: CNF, SP, KB, carbon nano-rods, doped-carbon, amorphous carbon, crystalline carbon, graphite, graphene, and mixtures and combinations thereof. The ratio of 1D to 0D carbon may range between 0.5 and 2. In one example embodiment, the 1D:0D ratio is 1. The cathode active material may comprise NCA, NCM, lithium iron phosphate (LFP), lithium cobalt oxide (LCO), lithium manganese oxide (LMO) or mixtures and combinations thereof. The cell active ion may comprise lithium. The anode active material may comprise one or more of lithium, sodium, potassium, silicon and mixtures and combinations thereof. The anode active material may comprise silicon, where the silicon ranges between 50-95% of the anode active material.

In an example scenario, the carbon material or carbon particles may comprise between 1 and 40% of the active material composition, with between 60% and 99% silicon. The 0D particles may have a largest diameter of 50 nm, and may comprise a porous and high surface area carbon material such as SuperP, Ketjen Black, and other such materials. The 1D particles may have an aspect ratio of at least 20 and may comprise a tubular or fiber-like carbon source with nanoscale structures in two-dimensions such as carbon nanotubes, carbon nanofibers (CNF), and vapor grown carbon fibers (VGCF), for example.

The 2D carbon structures may have an average dimension in the micron scale in each of the two non-nanoscale dimensions, between 1 and 30 μm, for example. Furthermore, the active material may comprise 3D carbon, such as graphite, where the material is not limited to nanoscale in any one dimension. Although the anode forming process above illustrates carbon incorporated into silicon, the disclosure is not so limited, as other anode materials and combinations are possible using materials such as lithium, sodium, potassium, silicon, and mixtures and combinations thereof.

A ternary carbon mixture may be selected from 0D, 1D, and 2D/3D carbon, where the 0D carbon comprises such as KB, SP, or doped porous carbon nanoparticles, the 1D carbon comprises VGCF, CNF, or carbon nano-rods, and the 2D/3D carbon comprises graphene or graphite, for example. Alternatively, the carbon mixture may be selected from amorphous carbons (0D and 1D) and crystalline carbons (1D-3D), and combinations thereof.

In an example embodiment of the disclosure, a method and system are described for a battery with carbon compositions as conductive additives for dense and conductive cathodes. The battery may comprise an anode, an electrolyte, and a cathode comprising an active material. That cathode active material may comprise 0D conductive carbon particles with nanoscale structure in three dimensions and 1D conductive carbon particles with nanoscale structure in two dimensions, where the 1D carbon particles have a diameter of less than 120 nm and a surface area of 30 m²/g. The cathode active material may comprise nickel cobalt aluminum oxide (NCA), nickel cobalt manganese oxide (NCM), lithium iron phosphate (LFP), lithium iron phosphate (LFP), lithium cobalt oxide (LCO), lithium manganese oxide (LMO), or mixture(s) and combination(s) thereof.

The 0D and 1D particles may comprise between 1% and 10% of the active material. The anode may comprise an active material that comprises between 20% to 95% silicon or between 50% to 95% silicon. The 0D conductive carbon particles may have a diameter of 50 nm or less. The 1D conductive carbon particles may comprise carbon nanotubes, carbon nanofibers (CNF), and/or vapor grown carbon fibers (VGCF). The 1D conductive carbon particles may have an aspect ratio of 20 or greater. The active material may comprise 2D conductive carbon particles. The battery may comprise a lithium ion battery. The electrolyte may comprise a liquid, solid, or gel.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry or a device is “operable” to perform a function whenever the battery, circuitry or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1-20. (canceled)

21. A battery, the battery comprising:
an anode, an electrolyte, and a cathode comprising an active material, the active material comprising:
0D conductive carbon particles with nanoscale structure in three dimensions; and
1D conductive carbon particles with nanoscale structure in two dimensions;
wherein a ratio of the 1D conductive carbon particles to the 0D conductive carbon particles in the active material is between 0.5 and 2.

22. The battery according to claim 21, wherein the ratio of the 1D conductive carbon particles to the 0D conductive carbon particles in the active material is approximately 1.

23. The battery according to claim 21, wherein the 0D and 1D particles comprise between 1% and 10% of the active material.

24. The battery according to claim 21, wherein the 0D conductive carbon particles have a diameter of 50 nm or less.

25. The battery according to claim 21, wherein the 1D conductive carbon particles comprise carbon nanotubes, carbon nanofibers (CNF), and/or vapor grown carbon fibers (VGCF).

26. The battery according to claim 21, wherein the 1D conductive carbon particles have an aspect ratio of 20 or greater.

27. The battery according to claim 21, wherein the active material further comprises 2D conductive carbon particles.

28. The battery according to claim 21, wherein the cathode active material comprises nickel cobalt aluminum oxide (NCA), nickel cobalt manganese oxide (NCM), lithium iron phosphate (LFP), lithium iron phosphate (LFP), lithium cobalt oxide (LCO), lithium manganese oxide (LMO), or mixtures and combinations thereof.

29. The battery according to claim 21, wherein the anode comprises an active material that comprises between 20% to 95% silicon.

30. The battery according to claim 21, wherein the electrolyte comprises a solid, a gel, a solid lithium ion conductor, or a semi-solid lithium ion conductor.

31. The battery according to claim 21, wherein the 1D conductive carbon particles have a diameter of less than 120 nm, a surface area of at least 30 m²/g, and/or a dispersive surface energy of more than 180 mJ/m².

32. A method of forming a battery, the method comprising:
forming a battery comprising an anode, an electrolyte, and a cathode comprising an active material, the active material comprising:
0D conductive carbon particles with nanoscale structure in three dimensions; and
1D conductive carbon particles with nanoscale structure in two dimensions;
wherein forming the battery comprises setting or ensuring that a ratio of the 1D conductive carbon particles to the 0D conductive carbon particles in the active material is between 0.5 and 2.

33. The method according to claim 32, wherein the ratio of the 1D conductive carbon particles to the 0D conductive carbon particles in the active material is approximately 1.

34. The method according to claim 32, wherein the 0D and 1D particles comprise between 1% and 10% of the active material.

35. The method according to claim 32, wherein the 0D conductive carbon particles have a diameter of 50 nm or less.

36. The method according to claim 32, wherein the 1D conductive carbon particles comprise carbon nanotubes, carbon nanofibers (CNF), and/or vapor grown carbon fibers (VGCF).

37. The method according to claim 32, wherein the 1D conductive carbon particles have an aspect ratio of 20 or greater.

38. The method according to claim 32, wherein the active material comprises 2D conductive carbon particles.

39. The method according to claim 32, wherein the cathode active material comprises nickel cobalt aluminum oxide (NCA), nickel cobalt manganese oxide (NCM), lithium iron phosphate (LFP), lithium iron phosphate (LFP), lithium cobalt oxide (LCO), lithium manganese oxide (LMO), or mixtures and combinations thereof.

40. The method according to claim 32, wherein the anode comprises an active material that comprises between 20% to 95% silicon.

41. The method according to claim 32, wherein the electrolyte comprises a solid, a gel, a solid lithium ion conductor, or a semi-solid lithium ion conductor.

42. The method according to claim 32, wherein the 1D conductive carbon particles have a diameter of less than 120 nm, a surface area of at least 30 m²/g, and/or a dispersive surface energy of more than 180 mJ/m².
